(19) United States
(12) Patent Application Publication
(10) Pub. No.: US 2014/0342110 A1
(43) Pub. Date: Nov. 20, 2014

(54) Thermoplastic Polyurethane From Low Free Monomer Prepolymer

(71) Applicant: Chemtura Corporation, Middlebury, CT (US)

(72) Inventors: Zhenya Zhu, New Milford, CT (US); Ronald O. Rosenberg, Orange, CT (US)

(73) Assignee: Chemtura Corporation, Middlebury, CT (US)

(21) Appl. No.: 14/257,222

(22) Filed: Apr. 21, 2014

Related U.S. Application Data
(60) Provisional application No. 61/823,426, filed on May 15, 2013.
(60) Provisional application No. 61/826,129, filed on May 22, 2013.
(60) Provisional application No. 61/866,620, filed on Aug. 16, 2013.

(51) Int. Cl. C08G 18/10; C08G 18/48; C08G 18/42; C08G 18/76

(52) U.S. Cl. CPC C08G 18/10; C08G 18/7614; C08G 18/4854; C08G 18/4277
USPC 428/36.9; 528/44

(57) ABSTRACT

Thermoplastic polyurethane (TPU) made using low free isocyanate monomer (LF) prepolymer, for example a prepolymer based on p-phenylene diisocyanate (PPDI) with low free isocyanate content, possess unique performance features including exceptional tear strength, low compression set, and an exceptional overall balance of physical properties including high temperature mechanical strength.

This application claims benefit under 35 USC 119(e) of U.S. Provisional Application No. 61/823,426, filed May 15, 2013; 61/826,129, filed May 22, 2013; and 61/866,620, filed Aug. 15, 2013, the disclosures of which are incorporated herein by reference.

Thermoplastic polyurethane (TPU) made from low free monomer (LF) prepolymer, for example low free p-phenylene diisocyanate (PPDI) monomer, exhibits exceptional tear strength, low compression set, balanced mechanical strength and has excellent prossessability.

### BACKGROUND OF THE INVENTION

Polyurethane polymers, e.g., elastomeric polyurethane, are well known as tough engineering materials. Polyurethanes also have found great success, for example, in coatings, foams and adhesives. Thermoset and elastomeric polyurethanes are often formed during application by reacting a curing agent or cross linker with a urethane prepolymer, the prepolymer is typically prepared by reacting a polyol and a polyisocyanate. For example, a composition containing a prepolymer and curing agent is formed and applied as a coating or adhesive, or cast into a mold prior to curing to form the final polyurethane material. Elastomeric and thermoset polyurethanes exhibit much higher load bearing properties than other natural and synthetic rubber materials, but many of these urethanes lose properties at high temperatures, e.g., urethanes can experience reductions in mechanical strength and performance at elevated temperature.

Thermoplastic polyurethanes (TPUs) are fully cured polymer resins that can be stored as a solid plastic and then remelted and molded into different shapes and articles. The components that make up an elastomeric or thermoset polyurethane resin are in many cases the same or similar to those used in preparing thermoplastic polyurethane; however, the properties of the final polymer are different. largely due to the manner in which the polymers are formed and processed.

For example, U.S. Pat. No. 5,959,059 discloses thermoplastic polyurethanes prepared by reacting diphenylmethane diisocyanate with a mixture of a polyol and a diol crosslinker at temperatures of from 110° C. to 170° C.

U.S. Pat. No. 4,447,590 discloses polyurethane prepared from a de-aerated emulsion comprising an aliphatic di-isocyanate, a PTMG polyol (polytetramethylene glycol) and butane diol. The resulting polyurethane was processed in an extruder at temperatures of ˜160° C.

Prepolymers containing low levels of free isocyanate monomers, less than 3% by weight, are known and have been used in the preparation of elastomeric polyurethanes, for example, U.S. Pat. No. 5,703,193 and US Pat Appl 20090076239, the disclosures of which are incorporated herein by reference. Such elastomeric polyurethanes have been used to good advantage in a variety of applications such as rollers, golf ball covers etc. Prepolymers containing very low levels of free isocyanate monomers, less than 1% by weight, are also known and elastomeric polyurethane produced therefrom has been found to have excellent handling and performance properties.

For example, p-phenylene diisocyanate (PPDI) based urethane prepolymers provide elastomers exhibiting excellent mechanical properties for many demanding applications. It has been found that this is particularly true for PPDI based urethanes made from prepolymers with a very low concentration of free isocyanate monomer. It has been postulated that prepolymers with low free isocyanate monomer provide cured polyurethanes with a well-defined molecular structure that promotes excellent phase segregation between hard domain and soft domain. Elastomers made from these low free monomer PPDI prepolymers exhibit enhanced toughness and creates high rebound materials, while providing excellent service at high temperatures.

PPDI based elastomeric polyurethanes are typically prepared as hot cast polyurethanes (CPU). These elastomers have many excellent properties, but they are not always suitable for certain applications, for example, they possess inadequate tear strength for some uses. Ether backbone materials often exhibit relatively weak tear properties limiting their use in applications requiring high cut and tear resistance. High compression set at elevated temperature may also not satisfy the requirement for the seal and gasket market. Furthermore, hot casting processes are not always as efficient the thermoplastic melt processing such as extrusion and melt injection molding, and may not be the desirable way for large scale production.

Thermoplastic PPDI polyurethanes are also known to possess excellent toughness and other desirable physical properties. U.S. Pat. No. 5,066,762 discloses a TPU resins prepared from a PPDI/polycarbonate prepolymer and a C₂₋₁₀ diol by reacting the prepolymer and C₂₋₁₀ diol at temperatures up to 90° C. and then further curing the polymer in a hot air oven at temperatures of from 105° C. to 170° C.

One drawback with PPDI TPUs is that processing, e.g., molding or extruding the polymer in the melt, may be difficult. U.S. Pat. No. 6,521,164 discloses a TPU prepared from a PPDI/polycaprolactone prepolymer and a mixed diol curing agent, which TPU has improved injection moldability than TPUs such as those disclosed in U.S. Pat. No. 5,066,762.

It has been found that thermoplastic polyurethanes prepared from low free monomer prepolymers, for example, prepolymers with low or very low levels of free PPDI, TDI, MDI etc., can be prepared by curing and thermally processing under select conditions to provide a material having balanced and improved mechanical properties, excellent properties at high temperature, and great efficiency in processing.

### SUMMARY OF THE INVENTION

Thermoplastic polyurethane polymers (TPU) are obtained by a process wherein a polymer produced by reacting a urethane prepolymer having a free polyisocyanate monomer content of less than 1% by weight with a curing agent is thermally processed by extrusion at temperatures of 150° C. or higher, e.g., 190° C. or higher, to form the thermoplastic polyurethane polymer.

The urethane prepolymer is typically prepared from a polyisocyanate monomer and a polyol comprising an alkane diol, polyether polyol, polyester polyol, polycaprolactone polyol and/or polycarbonate polyol. The curing agent typically comprises a diol, triol, tetrol, diamine or diamine derivative.

In some embodiments of the invention, the thermoplastic polyurethane polymer (TPU) is prepared by a process comprising curing a low free isocyanate prepolymer, i.e., less than 1% by weight of free isocyanate monomer, with a curing agent to form a urethane polymer, heating the urethane polymer thus obtained in a post curing step and extruding the post cured polymer at elevated temperature. In other embodiments, the TPU is prepared through a reactive extrusion process wherein low free isocyanate prepolymer and curing agent are fed directly into an extruder, mixed, reacted, and extruded out at elevated temperature.

Other processing steps, e.g., grinding the polymer before extrusion, pelletizing the TPU, etc. may also occur. The thermoplastic polyurethane of the invention has many improved physical properties when compared to similar thermoset and elastomeric materials, and also when compared to other thermoplastic materials prepared from a prepolymer with higher free polyisocyanate monomer content. Examples of improved properties can include greater tear strength, better modulus retention at high temperature, low compression set and the like, improved retention of physical properties over time and upon exposure to harmful environments, and a more readily processed polymer. The polymers of the invention thus have characteristics that are highly desirable for oil, mining, automotive and other industries demanding high performance.

### DESCRIPTION OF THE INVENTION

The TPUs of the invention are prepared from urethane prepolymers having low free isocyanate content and a curing agent by a process which involves extrusion of the polymer at elevated temperature. The low free isocyanate monomer prepolymers, prepared from polyols and polyisocyanate monomers, are typically very low in free polyisocyanate content, e.g., less than 1% by weight, often less than 0.5% and frequently less than 0.1% by weight.

The thermoplastic polyurethane polymer of the invention is obtained by a process wherein a polymer is produced by reacting a urethane prepolymer having a free polyisocyanate monomer content of less than 1% by weight with a curing agent and which polymer is thermally processed by extrusion at temperatures of 150° C. or higher, e.g., 190° C. or higher, or 200° C. or higher.

The urethane prepolymer is prepared from a polyisocyanate monomer and a polyol and more than one prepolymer may be used. The polyol typically comprises an alkane diol, polyether polyol, polyester polyol, polycaprolactone polyol and/or polycarbonate polyol, for example, a polyether polyol, polyester polyol, polycaprolactone polyol and/or polycarbonate polyol. The term “comprises a”, “comprises an” and the like means that one or more than one may be present. In some embodiments of the invention more than one polyol is used in preparing the prepolymer.

In many embodiments, the low free monomer prepolymers are prepared from, for example, alkylene polyols, polyether polyols such as PTMG, polyester polyols, polycaprolactone polyols, polycarbonate polyols, and polyisocyanate monomers such as, for example, para-phenylene diisocyanate (PPDI), diphenylmethane diisocyanate (MDI), isomers of toluene diisocyanate (TDI), hexamethylene diisocyanate (HDI), dicyclohexylmethane diisocyanate (H₁₂MDI) and the like. As stated above for the polyol, one or more than one polyisocyanate monomer can be used.

In one particular embodiment the polyol comprises a polyether polyol such as poly tetramethyl glycol (PTMG), either alone or with other polyols. In another embodiment the polyol comprises for example, a polycaprolactone polyol, either alone or with other polyols, a polyester polyol either alone or with other polyols, or a polycarbonate polyol either alone or with other polyols.

While almost any polyisocyanate monomer may be used in the invention, typically the polyisocyanate monomer comprises a di-isocyanate, for example, PPDI, MDI, TDI, HD₁, H₁₂MDI and the like. In certain embodiments the polyisocyanate monomer comprises para-phenylene diisocyanate, isomers of toluene diisocyanate, hexamethylene diisocyanate or dicyclohexylmethane diisocyanate, e.g., para-phenylene diisocyanate, hexamethylene diisocyanate or dicyclohexylmethane diisocyanate. In certain particular embodiments the polyisocyanate monomer comprises para-phenylene diisocyanate and/or hexamethylene diisocyanate.

Curing agents, also called coupling agents or cross linking agents, are well known in the art and any that provide the desired properties can be employed. The curing agent in many examples comprises a diol, triol, tetrol, diamine or diamine derivative, examples of which include, among others, ethane diol, propane diol, butane diol, cyclohexane dimethanol, hydroquinone-bis-hydroxyalkyl ether such as hydroquinone-bis-hydroxyethyl ether, diethylene glycol, dipropylene glycol, dibutylene glycol, triethylene glycol and the like, dimethylthio-2,4-toluenediamine, di-p-aminobenzoate, phenyldiethanol amine mixture, methylene dianiline sodium chloride complex and the like. Again, one or more than one curing agent may be used.

In many embodiments the curing agent comprises a diol or other polyol. In one particular embodiment, the curing agent comprises a diol, a blend of diols, or a blend of diols and triols, e.g., a C₂₋₆ diol, cyclohexane dimethanol and/or hydroquinone-bis-hydroxyethyl ether. In certain particular embodiments the curing agent comprises 1,4-butane diol and/or hydroquinone-bis-hydroxyethyl ether, for example, 1,4-butanediol. The curing agent may also comprise alkylene polyols, polyether polyols such as PTMG, polyester polyols, polycaprolactone polyols or polycarbonate polyols. These polyols may be used alone or as a blend with a diol or triol.

The polyols, polyisocyanates, and curing agents above are all known materials.

As mentioned above, the TPUs of the invention have many exceptional qualities relative to other polyurethane polymers. Further analysis of GPC suggested a narrower MW distribution of the present TPU polymers vs other similar polyurethanes. A more narrow melting range was observed by DSC for the TPUs of the invention than for cast polyurethanes of the same chemical composition. Not wanting to be bound by theory, it is believed that the excellent physical properties of the inventive polymers may be due to a combination of several factors, including: 1) use of a urethane raw material with a compact, linear, and symmetrical structure, 2) the low free monomer content of the prepolymer producing a polymers with excellent regularity that promotes phase separation after chain extension; and 3) a TPU formation process involving high temperature annealing and mechanical shearing, i.e., extrusion at elevated temperature, which promotes the morphology optimization of the urethane polymer and thus enhancing performance.

The prepolymer of the invention can be reacted with the curing agent under any conditions known in the art, provided that the polymer being formed is thermally processed as described above.

For example, in one embodiment the TPU of the invention is prepared by:

reacting a polyurethane prepolymer having low free isocyanate monomer content and a curing agent, typically at temperatures of from about 50° C. to about 150° C., for example, from about 50° C. to about 100° C., although temperatures outside these ranges may be employed in certain circumstances;
post curing the thus obtained polyurethane by heating the product at temperatures of from about 50° C. to about 200° C., e.g., from about 100° C. to about 150° C., for about 1 hour to about 24 hours; and
extruding the post cured polyurethane polymer, e.g., in a twin screw extruder, at temperatures from about 150° C. to about 270° C., e.g., 190° C. or higher to provide the thermoplastic polyurethane.

Other optional processing steps may be included in the process above, for example, a process comprising:

reacting a polyurethane prepolymer having low free isocyanate monomer content and a curing agent;
post curing the polyurethane;
(optionally) granulating the post cured polyurethane polymer;
extruding the post cured (and optionally granulated) polyurethane polymer;
(optionally) pelletizing the extruded TPU.

In one particular embodiment the TPU is obtained by a process wherein:

i) a prepolymer having a free isocyanate monomer content of less than 1% is mixed with a curing agent at temperatures of from about 50° C. to about 150° C. to form a polymer, followed by
ii) heating the polymer from i) at temperatures of from about 50° C. to about 200° C. for about 1 to about 24 hours to obtain a post cured polymer;
iii) optionally granulating the post cured polymer from step ii, to obtain a granulated polymer,
iv) processing the post cured polymer from step ii), or the granulated polymer from step iii), in an extruder at temperatures of 150° C. or higher to yield the TPU; and
v) optionally pelletizing the TPU;
and where in many embodiments the prepolymer is prepared, for example, from a polyisocyanate monomer comprising para-phenylene diisocyanate, isomers of toluene diisocyanate, hexamethylene diisocyanate or dicyclohexylmethane diisocyanate and a polyol comprising an alkane diol, polyether polyol, polyester polyol, polycaprolactone polyol or polycarbonate polyol, and the curing agent comprises a diol, triol, tetrol, diamine or diamine derivative;
for example wherein the prepolymer is prepared, from a polyisocyanate monomer comprising para-phenylene diisocyanate, hexamethylene diisocyanate or dicyclohexylmethane diisocyanate and a polyol comprising a polyether polyol, polyester polyol, polycaprolactone polyol or polycarbonate polyol, and the curing agent comprises a diol.

In another embodiment the TPU is prepared by feeding a low free monomer prepolymer and curing agent into an extruder where they are mixed and reacted, then extruded, e.g., in a twin screw extruder, at temperatures from about 150° C. to about 270° C., e.g., 190° C. or higher to provide the thermoplastic polyurethane, which may optionally be pelletized.

One aspect of the invention relates to the process by which the TPU is prepared. In a broad sense this entails curing a lower free isocyanate monomer prepolymer with a curing agent, heating the polymeric material obtained and extruding the polymer under melt conditions, i.e., under conditions whereby the polyurethane is molten. In an alternative process, the TPU may be made through reactive extrusion, wherein low free isocyanate monomer prepolymer and curing agent are be fed directly into an extruder, wherein the components are mixed and reacted, then extruded out. Typically the TPU obtained is either pelletized, which pellets may be further processed into final articles, or molded under melt conditions. TPU pellets of course may be molded into various articles the parts based on target applications.

For example, one embodiment provides a process for preparing a TPU comprising steps wherein

i) a low free monomer prepolymer, e.g., <1 wt % free isocyanate, and curing agent are mixed, typically at temperatures of from about 50° C. to about 150° C., e.g., from about 50° C. to about 100° C. to affect preliminary cure followed by
ii) further heating at temperatures of from about 50° C. to about 200° C., e.g., from about 100° C. to about 200° C., e.g., from about 50° C. to about 150° C. for about 1 to about 24 hours, to provide a postcured material,
iii) optionally, the postcured material is processed to make introduction into an extruder more facile, e.g., by granulation, and
iv) extruding the material from step ii) or step iii) at temperatures of 150° C. or higher.

Many embodiments further include a step v) wherein the TPU is pelletized. Various process steps can be combined into one physical step, for example steps i) and ii) can be carried out in sequence in the same reaction vessel as a single physical process.

In the above process, step i) can be accomplished in any convenient manner for forming elastomeric polyurethanes, for example by making use of any standard protocol for cast curing a polyurethane. Postcuring in step ii) is likewise carried out in any convenient manner, e.g., within a heated mold or container or in an oven etc. The temperatures under which curing and postcuring occurs can frequently impact the properties of the polymer obtained and are readily optimized by one skilled in the art depending on the prepolymer(s) and curing agent(s) used, but typically occur at temperatures at 50° C. or higher.

The temperatures of extrusion step iv) may also vary somewhat depending on the polymer resin being prepared and the extruder being used, e.g., a single screw or twin screw extruder may be used, often a twin screw extruder is employed. Temperatures of from about 150° C. to about 270° C. are frequently encountered, but in many embodiments the extruder is operated at temperatures of 190° C. or higher, for example, in some embodiments excellent results are achieved extrusion temperatures of 200° C. or higher, e.g., 200° C. to about 270° C., for example, from about 200° C. to about 250° C., such as from about 200° C. to about 230° C.

In an alternative process whereby the TPU is prepared by reactive extrusion of a mixture comprising low free monomer prepolymer and curing agent, extruder temperatures will vary from 50° C. to 270° C. depending on the materials used and the final properties desired. Such a process will often make use of different temperatures within different domains of the extruder, for example, the reaction may occur in a part of the extruder at one temperature, and other temperatures may be found in other parts of the extruder. This is common in the art where the hopper may be at one temperature and various zones in the extruder chamber may be at different temperatures. These differences in temperatures may also be found when performing the exudation step of a cast cured polyurethane.

The relative amounts of prepolymer and curing agent are typical of those encountered in the art. For example, in one embodiment, a low free monomer prepolymer is mixed with a diol type curing agent, for example 1,4 Butanediol or HQEE (hydroquinone bis(2-hydroxyethyl)ether), in a molar ratio of isocyanate groups to hydroxyl groups of about 0.95 to about 1.10, or expressing in another way, 95% to 110% of stoichiometry. For example, a molar ratio of about 0.97 to about 1.05, or 97% to 105% of stoichiometry.

In general, TPUs of the invention exhibit exceptional mechanical strength, trouser tear strength, split tear strength, low compression set, modulus retention and low tan delta (damping) values. The balanced set of physical and chemical properties of the inventive TPUs are typically not found in other similar polyurethanes, such as other commercially available TPUs or cast elastomeric polyurethanes. For example, TPUs of the invention are typically more readily processed, e.g., extruded, injection molded etc., than many TPUs while exhibiting better property retention at elevated temperature. The TPUs also show a greater resistance to loss of physical properties upon exposure to thermal aging and other environmental conditions such as elevated temperature exposure to oil, water, acids and bases.

For example, a TPU of the invention was prepared by reacting a PPDI/PTMG prepolymer having about 5.6 wt % of available isocyanate groups and containing approximately 0.1 wt % or less free isocyanate monomer with 1,4 butanediol, curing at 100° C. for 24 hours and then extruding the resulting polyurethane in a twin-screw extruder at 200-230° C. Injection molded samples made from the TPU, Ex 1 in the table below, was compared to the samples made from a cast elastomeric polyurethane (CPU) prepared from the same prepolymer and curing agent, Comp A in the table below. TPU samples of the invention displayed higher tear strength and lower compression set than their cast PUR counterparts. It should be noted that the lower compression set data of the present TPUs were measured after significantly longer times than that of the cast PURs, 70 hours vs 22 hours. Details can be found in the Examples.

| | Ex I | Comp A |
|---|---|---|
| Hardness | 97A | 98A |
| Split Tear, kN/m | 46.2 | 16.1 |
| Trouser Tear, kN/m | 59.4 | 24.3 |
| Compression set 100° C. | 33% (70 h) | 48% (22 h) |

TPUs prepared from low free monomer MDI terminated prepolymers were also prepared according to the present invention and compared with commercially available MDI based TPU. In the table below, Ex V is a TPU of the invention prepared from a MDI/PTMG prepolymer having about 5.0 wt % of available isocyanate groups and containing less than 1 wt % free isocyanate monomer and a proprietary diol, Ex VI is a TPU of the invention prepared from a MDI/Polycaprolactone prepolymer having about 4.5 wt % of available isocyanate groups and containing less than 1 wt % free isocyanate monomer. Injection molded samples from the inventive TPUs were compared with injection molded samples prepared from commercially available MDI/Polyether TPU, Comp C′. As can be seen from the data below, TPUs of the invention exhibit higher cut and tear strength and better modulus retention at elevated temperature than the commercially obtained TPU. Details can be found in the Examples.

| | Ex V | Ex VI | COMP C′ |
|---|---|---|---|
| Hardness | 93A | 90A | 90A |
| Split Tear (D 470), kN/m | 41.2 | 29.8 | 18.9 |
| Storage Modulus, Mdyn/cm² | | | |
| @ 30° C. | 298 | 133 | 217 |
| @ 100° C. | 177 | 83 | 70 |
| Modulus ratio 100° C./30° C. | 0.59 | 0.62 | 0.32 |

TPUs of the invention prepared from low free monomer PPDI terminated prepolymers illustrate an extremely tough and durable embodiment of the invention exhibiting excellent initial properties and excellent property retention. For example, TPUs were prepared from a PPDI/polycaprolactone prepolymer with less than 0.1 wt % free isocyanate free monomer and a proprietary diol, and a PPDI/polycarbonate prepolymer with less than 0.1 wt % free isocyanate free monomer and the same proprietary diol according to the present invention, and compared with their cast polyurethane counterparts. The TPUs of the invention exhibited greater split tear strength and lower compression set than their cast PUR counterparts. Notably, the PPDI TPUs of the invention retained 90% or more of their initial modulus and split tear strength after 21 days of aging in a 150° C. forced air oven. Details can be found in the Examples.

The PPDI/polycarbonate TPU of Example X, details are in the Examples, was exposed at 85° C. under a variety of conditions, and as shown in the examples, retained 90% of its original split tear strength when exposed in the presence of 5% NaOH aqueous solution and 98-100% of its original split tear strength when exposed in the presence of water or 5% HCl aqueous solution.

One particular embodiment relates to PPDI based TPUs. For example, as shown above, TPUs prepared from low free isocyanate monomer PPDI/polycarbonate prepolymers are excellent candidates for hot, wet and aggressive environments in either static or dynamic applications such as oil, gas, and mining fields, where TPU parts may work in humid and/or oily environment at elevated temperature, under load and speed. As another example, TPUs from low free isocyanate monomer PPDI/polycaprolactone prepolymers are well suited for applications demanding toughness, low set in compression, and high temperature resistance such as industrial belts, seal/gaskets, and gears. TPUs from low free isocyanate monomer PPDI/polyether prepolymers are well suited for applications requiring resilience, high tear strength, low temperature flexibility, and performance under dynamic load, examples include sports and recreation goods and engineering parts.

Of course individual polymers of the invention will find use in arenas outside these few examples. In many instances, the TPU of the invention can serve as a replacement for applications currently using non-PUR rubber.

HNBR type rubber is well known for its property retention after long-term exposure to heat and oil. This has resulted in the adoption of HNBR in assorted applications on the high temperature market. Thermoplastic urethanes based on LF technology and selected building blocks also resist heat, oil and other abusive conditions. In the following table, the performance before and after 21 days of heating in a forced air oven at 150° C. of HNBR rubber cured with peroxide to a Shore Hardness of 90 A was compared to that of a PPDI/polycarbonate TPU of the invention, Ex X in the table, and a PPDI/polycaprolactone TPU of the invention Ex VII in the table. Details can be found in the Examples.

| | Ex X | | Ex VII | | HNBR | |
|---|---|---|---|---|---|---|
| Hardness | 93A | | 93A | | 90A | |
| days @ 150° C. | 0 | 21 | 0 | 21 | 0 | 21 |
| 100% modulus, MPa | 10.2 | 10.1 | 8.6 | 7.8 | 14.3 | — |
| Tensile, MPa | 40.4 | 44.2 | 43.5 | 27.0 | 19.5 | 20.8 |
| Elongation, % | 530 | 680 | 760 | 890 | 210 | 50 |
| Break Energy, MPa | 21,410 | 30,060 | 33,100 | 24,030 | 4,100 | 1,040 |
| Split Tear, kN/m | 34.7 | 35.7 | 35.6 | 33.0 | 4.4 | 3.2 |

Compared to the peroxide cured HNBR, TPUs of the invention are much tougher in terms of initial tensile strength, elongation, and tear properties. It is also clear that the TPUs of the invention retain their physical properties much better than the NHBR sample after heating at 150° C.

In addition to the excellent performance properties exhibited by the thermoplastic polyurethanes of the invention, the present TPUs are more readily melt processed than other commercial TPUs. For example, the TPU of the invention, often in the form of pellets, can be molded under melt conditions such as extrusion, co-extrusion, compression molding, injection molding etc., to form a variety of articles, in many cases at lower temperatures than similar materials.

A TPU of the invention prepared from a PPDI/polycarbonate prepolymer having about 3.8% wt of available isocyanate groups and free diisocyanate content <0.1 wt % and HQEE was compared to Comp J, a TPU prepared from a PPDI/polycarbonate prepolymer having about 6.0% wt of available isocyanate groups and free diisocyanate content of ˜4.0 wt % and HQEE, and also to Comp K, a commercial PPDI based TPU.

The TPU of the present invention had a Melt Flow Index @ 230° C./2,160 g of 65 g/10 min and a melting point of 212° C. The other two TPUs had zero flow under these conditions and had melting points of 267° C. for Comp J, and >300° C. for Comp K. The TPU of the invention could be fully dissolved in an organic solvent and had a molecular weight as determined by GPC of Mn 86,000. The TPU prepared from the prepolymer having 4.0% free isocyanate monomer was only partially soluble and had a MW by GPC of Mn 37,000. The commercial TPU was insoluble and a MW was not determined. Details can be found in the Examples

One embodiment of the invention provides a TPU prepared according to the present methods from PPDI, MDI, TDI, HDI, or H₁₂MDI terminated polyether, polyester, polycaprolactone or polycarbonate prepolymers wherein the TPU has a molecular weight Mn 50,000 or higher, e.g., 60,000 or higher, or 70,000 or higher as determined by GPC. In a particular embodiment, the TPU has a molecular weight Mn of 50,000, 60,000, 70,000 or higher, and a melting point of 250° C. or less, e.g., 240° C. or less, 230° C. or less or 220° C. or less.

The present invention thus provides a TPU with excellent physical and processing properties, methods for preparing the TPU, articles formed from the TPU and the use of the TPU in the formation of any final article which can be prepared from thermoplastic polyurethanes e.g., by extrusion, injection, blow and compression molding equipment, including a variety of extruded film, sheet and profile applications, for example casters, wheels, covers for wheel rollers, tires, belts, sporting goods such as golf ball cores, golf ball covers, clubs, pucks, and a variety of other sporting apparatus and recreation equipment, footwear, protection equipment, medical devices including surgical instruments and body parts, interior, exterior and under the hood auto parts, power tools, hosing, tubing, pipe, tape, valves, window, door and other construction articles, seals and gaskets, inflatable rafts, fibers, fabrics, wire and cable jacketing, carpet underlay, insulation, business equipment, electronic equipment, connectors electrical parts, containers, appliance housings, toys etc., or parts contained by the preceding articles.

### EXAMPLES

For the following examples all performance data was acquired according to ASTM methods, hardness was measured with Shore A and D durometers, heat aging occurred in a 150° C. forced air oven, oil resistance was carried out in IRM#903 fluid based on ASTM D-471, hydrolysis, acid solution resistance tests, and base solution resistance tests were also carried out based on ASTM D-471.

### Example I

### TPU from Low Free Monomer PPDI/PTMG Prepolymer

15,000 grams of PPDI terminated, PTMG backbone prepolymer having about 5.6 wt % of available isocyanate groups and containing approximately 0.1 wt % or less free isocyanate monomer, i.e., ADIPRENE LFP 950A polyether prepolymer from Chemtura Corp., was mixed with 900 grams 1,4 butanediol and cured at 100° C. for 24 hours. The resulting polyurethane was granulated, processed through a twin-screw extruder at 200-230° C. and pelletized.

### Example II

### TPU from Low Free Monomer PPDI/Polycaprolactone Prepolymer

15,000 grams of PPDI terminated, polycaprolactone backbone prepolymer having about 3.8 wt % of available isocyanate groups and containing approximately 0.1 wt % or less free isocyanate monomer, i.e., ADIPRENE LFP 2950A polycaprolactone prepolymer from Chemtura Corp., was mixed with 610 grams 1,4 butanediol and was mixed, cured at 100° C. for 24 hours, granulated. The resulting polyurethane was granulated, processed through a twin-screw extruder at 200-230° C. and pelletized.

### Example III

### TPU from Low Free Monomer PPDI/PTMG Prepolymer

The prepolymer and butane diol of Example I are fed into an extruder, mixed and reacted during extrusion at elevated temperature and pelletized. The resulting pellets are optionally post cured at 100° C. for up to 24 hours prior to further processing.

### Example IV

### TPU from Low Free Monomer PPDI/Polycaprolactone Prepolymer

The prepolymer and butane diol of Example II are fed into an extruder, mixed and reacted during extrusion at elevated temperature and pelletized. The resulting pellets are optionally post cured at 100° C. for up to 24 hours prior to further processing.

### Comp Example A

### Cast PUR from Low Free Monomer PPDI/PTMG Prepolymer

100 grams of the prepolymer used in Example I was added to 5.7 grams of 1,4 butanediol, the mixture was fully agitated, poured into molds, and cured/post cured at 127° C. for 24 hours after which the polymer was removed from the mold.

### Comp Example B

### Cast PUR from Low Free Monomer PPDI/Polycaprolactone Prepolymer

100 grams of the prepolymer used in Example II was added to 3.9 grams of 1,4 butanediol, the mixture was fully agitated, poured into molds, and cured/post cured at 127° C. for 24 hours after which the polymer was removed from the mold.

### Comp Example C

### Commercially Available TPU

Commercially obtained MDI/polyether TPU, ESTANE 58212 ether based TPU from Lubrizol.

The TPU pellets from Examples I and II, and the commercial TPU of Comparative Example C were each injection molded to form test specimens which were tested for split tear strength, trouser tear strength and 100° C. compression set. The demolded cast polymer from Comparative Examples A and B were also tested in the same manner. TPUs of the invention, Ex I and Ex II, exhibit superior split tear and trouser tear strength when compared to their cast PUR counterparts and when compared to the commercially obtained TPU. The TPUs of the invention also have much lower compression set when compared to that of their cast PUR counterparts, even at prolonged time (70h vs. 22h).

The results are shown in Table 1.

TABLE 1

| Example | I | Comp A | II | Comp B | Comp C |
|---|---|---|---|---|---|
| Hardness | 97A | 98A | 93A | 95A | 95A |
| Split Tear, kN/m | 46.2 | 16.1 | 35.6 | 24.5 | 29.4 |
| Trouser Tear, kN/m | 59.4 | 24.3 | 129.6 | — | — |
| Compression set, | 33% (70 h) | 48% (22 h) | 48% (70 h) | 60% (22 h) | — |
| 100° C. | | | | | |

### Example V

### TPU from Low Free Monomer MDI/PTMG Prepolymer

MDI terminated, PTMG backbone prepolymer having about 5.0 wt % of available isocyanate groups and containing less than 1 wt % free isocyanate monomer was mixed with a proprietary diol, the mixture poured into a tray and heated at 100° C. for 16 hours. The resulting urethane polymer was granulated and processed in a twin-screw extruder at elevated temperature to provide the TPU in the form of pellets.

### Example VI

### TPU from Low Free Monomer MDI/Polycaprolactone Prepolymer

MDI terminated polycaprolactone backbone prepolymer having about 4.5 wt % of available isocyanate groups and containing less than 1 wt % free isocyanate monomer was mixed with a proprietary diol and the mixture was cured, granulated and extruded according to the process of Example V to provide the TPU in the form of pellets.

### Comp Example C′

### Commercially Available TPU

Commercially available MDI/polyether TPU similar to Comp Ex C.

The TPU pellets from Examples V and VI and the commercial TPU of Comparative Example C′ were each injection molded to form test specimens. Performance characteristics of the specimens from Ex V and VI are shown in Table 2.

TABLE 2

| Example | V | VI |
|---|---|---|
| Hardness | 93A | 90A |
| Rebound, % | 56 | 55 |
| 100% Modulus, Mpa | 10.2 | 7.5 |
| Tensile, Mpa | 32.8 | 30.8 |
| Elongation, % | 680 | 570 |
| Trouser Tear (D 1938), kN/m | 47.5 | 78.4 |
| Split Tear (D 470), kN/m | 41.2 | 29.8 |
| Compression Set @ 70° C./22 h, % | 55 | 28 |

Test specimens of the inventive TPUs from Ex V and VI are compared to those of the commercially obtained TPU of Comp Ex C′. The TPUs of the invention exhibit higher cut and tear strength and better modulus retention at elevated temperature than the commercially obtained TPU. Results are shown in Table 3.

TABLE 3

| Example | V | VI | COMP C′ |
|---|---|---|---|
| Hardness | 93A | 90A | 90A |
| Split Tear (D 470), kN/m | 41.2 | 29.8 | 18.9 |
| Storage Modulus, | 298 | 133 | 217 |
| Mdyn/cm² @ 30° C. | | | |
| @ 100° C. | 177 | 83 | 70 |
| Storage Modulus ratio | 0.59 | 0.62 | 0.32 |
| 100° C./30° C. | | | |

### Example VII

### TPU from Low Free Monomer PPDI/Polycaprolactone Prepolymer

PPDI terminated, polycaprolactone backbone prepolymer having about 4.0 wt % of available isocyanate groups and containing approximately 0.1 wt % or less free isocyanate monomer was mixed with a proprietary diol which was heated at 120° C. for 16 hours. The resulting urethane polymer was granulated, extruded and pelletized in Example Ito provide the TPU in the form of pellets.

### Example VIII

### TPU from Low Free Monomer PPDI/PTMG Prepolymer

Following the procedure of Example VII a PPDI terminated, PTMG backbone prepolymer having about 6.0 wt % of available isocyanate groups and containing approximately 0.1 wt % or less free isocyanate monomer and a proprietary diol were reacted and the product processed to provide the TPU in the form of pellets.

### Example IX

### TPU from Low Free Monomer PPDI/PTMG Prepolymer

Following the procedure of Example VII a PPDI terminated, PTMG backbone prepolymer having about 8.0 wt % of available isocyanate groups and containing approximately 0.1 wt % or less free isocyanate monomer and a proprietary diol were reacted and the product processed to provide the TPU in the form of pellets.

### Example X

### TPU from Low Free Monomer PPDI/Polycarbonate Prepolymer

Following the procedure of Example VII a PPDI terminated, polycarbonate backbone prepolymer having about 4.0 wt % of available isocyanate groups and containing approximately 0.1 wt % or less free isocyanate monomer and a proprietary diol were reacted and the product processed to provide the TPU in the form of pellets.

### Comp Example D

### Cast PUR from Low Free Monomer PPDI/Polycaprolactone Prepolymer

The prepolymer and diol of Example VIII was mixed, poured into molds, heated at 120° C. for 16 hours and demolded to provide the cast PUR polymer.

### Comp Example E

### Cast PUR from Low Free Monomer PPDI/PTMG Prepolymer

The prepolymer and diol of Example IX was mixed, poured into molds, heated at 120° C. for 16 hours and demolded to provide the cast PUR polymer.

### Comp Example F

### Cast PUR from Low Free Monomer PPDI/Polycarbonate Prepolymer

The prepolymer and diol of Example X was mixed, poured into molds, heated at 120° C. for 16 hours and demolded to provide the cast PUR polymer.

### Comp Example G

### Cast PUR from Low Free Monomer Polyester/TDI Prepolymer

TDI terminated, polyester glycol backbone prepolymer having about 4.2 wt % of available isocyanate groups and containing less than 0.1 wt % free isocyanate monomer was mixed with 4,4′-methylene-bis-(ortho chloroaniline). The mixture was fully agitated, poured into molds, heated at 100° C. for 16 hours and demolded to provide the cast PUR polymer.

### Comp Example H

### Commercially Available TPU

Commercially available TPU prepared from a MDI/polyether prepolymer similar to Comp Ex C.

The TPU pellets from Examples VII, VIII, IX and X, and the commercial TPU of Comparative Example H were each injection molded to form test specimens. Performance characteristics of the specimens from Examples VII, VIII, IX and X are shown in Table 4.

TABLE 4

| Example | VII | VIII | IX | X |
|---|---|---|---|---|
| Hardness | 93A | 95A | 54D | 93A |
| Rebound, % | — | 63 | 50 | 46 |
| 100% Modulus, Mpa | 8.6 | 12.4 | 15.5 | 10.2 |
| Tensile, Mpa | 43.5 | 36.6 | 45.1 | 40.4 |
| Elongation, % | 760 | 660 | 840 | 530 |
| Trouser Tear, kN/m | 129.0 | 67.2 | 129.0 | 105.6 |
| Split Tear, kN/m | 35.6 | 44.4 | 54.0 | 34.7 |
| Compression Set @ | — | 35% | 34% | — |
| 70° C./22 h | | | | |
| Compression Set @ | 35% | — | — | 36% |
| 100° C./70 h | | | | |
| Tan Delta @ 30° C. | 0.027 | 0.025 | 0.036 | 0.052 |
| @ 120° C. | 0.028 | 0.038 | 0.033 | 0.026 |
| Tg, ° C. | −46 | −53 | −45 | −29 |

Various physical properties of the inventive TPUs from Ex VII, IX and X are compared to those of their cast PUR counterparts. TPUs of the invention, exhibit superior split tear strength and lower compression set when compared to that of their cast PUR counterparts. Results are shown in Table 5.

TABLE 5

| | Example | | | | | |
|---|---|---|---|---|---|---|
| | | COMP | | COMP | | COMP |
| | X | F | VII | D | IX | E |
| Hardness | 93A | 94A | 93A | 95A | 54D | 59D |
| 100% Modulus, MPa | 10.2 | 12.0 | 8.6 | 10.0 | 15.5 | 18.0 |
| Tensile, MPa | 40.4 | 50.0 | 43.5 | 45.0 | 45.1 | 56.0 |
| Elongation, % | 530 | 550 | 760 | 580 | 840 | 450 |
| Break Energy, × 1000 | 21.4 | 27.5 | 33.1 | 26.1 | 37.9 | 25.2 |
| (Tensile × Elongation) | | | | | | |
| Split Tear, kN/m | 34.7 | 27.8 | 35.6 | 25.0 | 54.0 | 23.0 |
| Compression Set, % | | | | | | |
| @ 100° C./70 hrs. | 36 | 47 | 35 | 68 | — | — |
| @ 70° C./22 hrs. | — | — | — | — | 34 | 48 |

Test specimens prepared from the inventive TPUs of Example X and VII, Comparative Example H and an HNBR rubber cured with peroxide to a Shore Hardness of 90 A were aged for 21 days at 150° C. in a forced air oven, after which the properties were measured and compared to the properties of unaged specimens. Results are shown in Table 6.

TABLE 6

| | Example | | | | | | | |
|---|---|---|---|---|---|---|---|---|
| | Example X | | Example VII | | COMP H | | HNBR | |
| Hardness | 93A | | 93A | | 90A | | 90A | |
| days @ 150° C. | 0 | 21 | 0 | 21 | 0 | 21 | 0 | 21 |
| 100% modulus, MPa | 10.2 | 10.1 | 8.6 | 7.8 | 8.3 | 4.4 | 14.3 | — |
| Tensile, MPa | 40.4 | 44.2 | 43.5 | 27.0 | 50.0 | 14.1 | 19.5 | 20.8 |
| Elongation, % | 530 | 680 | 760 | 890 | 525 | 650 | 210 | 50 |
| Break Energy, MPa | 21410 | 30,060 | 33100 | 24,030 | 26250 | 9,170 | 4,100 | 1,040 |
| Split Tear, kN/m | 34.7 | 35.7 | 35.6 | 33.0 | 25 | 11.7 | 4.4 | 3.2 |

Test specimens prepared from the inventive TPUs of Example X were aged for three weeks at 85° C. in water, 5% aq. HCL and 5% aq. NaOH, after which the properties were measured and compared to the properties of unaged specimens. Results are shown in Table 7.

TABLE 7

| | Original | H₂O | 5%HCl | 5%NaOH |
|---|---|---|---|---|
| Tensile, MPa | 40.4 | 36.0 | 29.9 | 23.6 |
| Split Tear, kN/m | 34.7 | 34.0 | 35.1 | 30.9 |

### Example XI

15,000 grams of a PPDI/polycarbonate prepolymer containing about 3.8% wt of available isocyanate groups and having free diisocyanate content <0.1 wt %, was mixed with 1,360 grams HQEE then cured at 100° C. for 24 hours and granulated. The granulated polymer was passed through a twin-screw extruder at 200-230° C. and pelletized.

### Comparative Example J

15,000 grams of a PPDI/polycarbonate prepolymer containing about 6.0% wt of available isocyanate groups and having free diisocyanate content of ˜4.0% wt %, was mixed with 2,140 grams HQEE then cured at 100° C. for 24 hours and granulated. The granulated polymer was passed through a twin-screw extruder at 220-250° C. and pelletized.

### Comparative Example K

### Commercial High Performance PPDI Based TPU

Characteristics relevant to thermal processing of the TPU from Ex XI, Comp J, and Comp K were measured and are shown in Table 8. The TPU of the invention has a lower melting point, and reasonable melt flow at 230° C. The TPU also has a higher molecular weight than Comp J and possibly a more linear in molecular structure as demonstrated by increased solubility in the GPC solvent.

| Example | XI | Comp J | Comp K |
|---|---|---|---|
| Melting point | 212° C. | 267° C. | >300° C. |
| Melt Flow Index @ | 65 | 0 | 0 |
| 230° C./2160 g, | | | |
| g/10 min. | | | |
| Molecular weight | 86,000 | Mn 37,000 | — |
| by GPC | | | |
| Solubility | Fully | Partially | Insoluble |

We claim:

1. A thermoplastic polyurethane polymer obtained by a process wherein a polymer produced by reacting a urethane prepolymer having a free polyisocyanate monomer content of less than 1% by weight with a curing agent is thermally processed by extrusion at temperatures of 150° C. or higher to form the thermoplastic polyurethane polymer.

2. The thermoplastic polyurethane polymer according to claim 1 wherein the urethane prepolymer is prepared from a polyisocyanate monomer and a polyol comprising an alkane diol, polyether polyol, polyester polyol, polycaprolactone polyol and/or polycarbonate polyol, and the curing agent comprises a diol, triol, tetrol, alkylene polyol, polyether polyol, polyester polyol, polycaprolactone polyol, polycarbonate polyol, diamine or diamine derivative.

3. The thermoplastic polyurethane polymer according to claim 2 wherein the polyisocyanate monomer comprises para-phenylene diisocyanate, isomers of toluene diisocyanate, hexamethylene diisocyanate or dicyclohexylmethane diisocyanate.

4. The thermoplastic polyurethane polymer according to claim 3 wherein the polyisocyanate monomer comprises para-phenylene diisocyanate or hexamethylene diisocyanate.

5. The thermoplastic polyurethane polymer according to claim 1 wherein the urethane prepolymer has a free polyisocyanate monomer content of less than 0.5%

6. The thermoplastic polyurethane polymer according to claim 2 wherein the curing agent comprises a diol, triol and/or tetrol.

7. The thermoplastic polyurethane polymer according to claim 6 wherein the curing agent comprises a C₂₋₆ diol, cyclohexane dimethanol or hydroquinone-bis-hydroxyethyl ether.

8. The thermoplastic polyurethane polymer according to claim 7 wherein the curing agent comprises 1-4-butane diol and/or hydroquinone-bis-hydroxyethyl ether.

9. The thermoplastic polyurethane polymer according to claim 2 wherein more than one prepolymer and/or more than one curing agent is used.

10. The thermoplastic polyurethane polymer according to claim 2 wherein the urethane prepolymer is prepared from more than one polyol and/or more than polyisocyanate.

11. The thermoplastic polyurethane polymer according to claim 1 obtained by a process wherein the polymer produced by reacting a urethane prepolymer having a free polyisocyanate monomer content of less than 1% by weight with a curing agent is processed by extrusion at temperatures of 190° C. or higher to form the thermoplastic polyurethane polymer.

12. The thermoplastic polyurethane polymer according to claim 1 obtained by a process wherein:
i) the prepolymer having a free isocyanate monomer content of less than 1% is mixed with a curing agent at temperatures of from about 50° C. to about 150° C. to form a polymer, followed by
ii) heating the polymer from i) at temperatures of from about 50° C. to about 200° C. for about 1 to about 24 hours to obtain a post cured polymer,
iii) optionally granulating the post cured polymer from step ii, to obtain a granulated polymer and
iv) processing the post cured polymer from step ii), or the granulated polymer from step iii), in an extruder at temperatures of 150° C. or higher,
wherein the urethane prepolymer is prepared from a polyisocyanate monomer comprising para-phenylene diisocyanate, isomers of toluene diisocyanate, hexamethylene diisocyanate or dicyclohexylmethane diisocyanate and a polyol an alkane diol, polyether polyol, polyester polyol, polycaprolactone polyol and/or polycarbonate polyol, and the curing agent comprises a diol, triol, tetrol, alkylene polyol, polyether polyol, polyester polyol, polycaprolactone polyol, polycarbonate polyol, alkylene polyol, polyether polyol, polyester polyol, polycaprolactone polyol, polycarbonate polyol, diamine or diamine derivative.

13. The thermoplastic polyurethane polymer according to claim 12 wherein the polyisocyanate monomer comprises para-phenylene diisocyanate, isomers of toluene diisocyanate, hexamethylene diisocyanate or dicyclohexylmethane diisocyanate.

14. The thermoplastic polyurethane polymer according to claim 12 wherein the curing agent comprises a C₂₋₆ diol, cyclohexane dimethanol or hydroquinone-bis-hydroxyethyl ether.

15. The thermoplastic polyurethane polymer according to claim 12 wherein more than one prepolymer and/or more than one curing agent are mixed in step i), and/or more than one polyol and/or more than polyisocyanate is used to prepare one or more prepolymer.

16. A process for preparing the thermoplastic polyurethane polymer according to claim 1 wherein a prepolymer having a free isocyanate monomer concentration of less than 1% and a curing agent are fed directly into an extruder, mixed and reacted, then extruded at temperatures of 150° C. or higher,
wherein the urethane prepolymer is prepared from a polyisocyanate monomer comprising para-phenylene diisocyanate, isomers of toluene diisocyanate, hexamethylene diisocyanate or dicyclohexylmethane diisocyanate and a polyol comprising an alkane diol, polyether polyol, polyester polyol, polycaprolactone polyol and/or polycarbonate polyol, and the curing agent comprises a diol, triol, tetrol, diamine or diamine derivative.

17. The thermoplastic polyurethane polymer according to claim 16 wherein the polyisocyanate monomer comprises para-phenylene diisocyanate, isomers of toluene diisocyanate, hexamethylene diisocyanate or dicyclohexylmethane diisocyanate.

18. The thermoplastic polyurethane polymer according to claim 16 wherein the curing agent comprises a C₂₋₆ diol, cyclohexane dimethanol or hydroquinone-bis-hydroxyethyl ether.

19. The thermoplastic polyurethane polymer according to claim 16 wherein more than one prepolymer, more than one curing agent, more than one polyol and/or more than polyisocyanate is used.

20. A process for preparing a thermoplastic polyurethane polymer wherein a polymer produced by reacting a urethane prepolymer having a free polyisocyanate monomer content of less than 1% by weight with a curing agent is processed by extrusion at temperatures of 150° C. or higher to form the thermoplastic polyurethane polymer.

21. A film, pellet, sheet, fiber or molded article comprising the thermoplastic polyurethane polymer according to claim 1.

22. Footwear, protection equipment, medical device, hosing, tubing, pipe, pump, tape, caster, wheel, roller, tire, belt, valve, window, door, seal, gasket, fabric, insulation, connector, container, appliance housing, golf ball, golf club, mining screen, or parts thereof comprising the thermoplastic polyurethane polymer according to claim 1.

23. A film, pellet, sheet, fiber or molded article comprising the thermoplastic polyurethane polymer according to claim 12.

24. Footwear, protection equipment, medical device, hosing, tubing, pipe, pump, tape, caster, wheel, roller, tire, belt, valve, window, door, seal, gasket, fabric, insulation, connector, container, appliance housing, golf ball, golf club, mining screen, or parts thereof comprising the thermoplastic polyurethane polymer according to claim 12.
